(19) United States
(12) Patent Application Publication
(10) Pub. No.: US 2007/0172248 A1
(43) Pub. Date: Jul. 26, 2007

(54) Charging voltage supply and method for supplying charging voltage

(75) Inventors: Joong-gwang Shin, Seongnam-si (KR); Yong-baek Yoo, Suwon-si (KR); Jin-cheol Kim, Suwon-si (KR); Yoo-seok Yang, Yongin-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/600,721

(22) Filed: Nov. 17, 2006

(30) Foreign Application Priority Data
Jan. 23, 2006 (KR) 2006-06684

(51) Int. Cl. G03G 15/00

(52) U.S. Cl. 399/89

(57) ABSTRACT

A charging voltage supply and a method for supplying a charging voltage are provided. The charging voltage supply generates a voltage and branches the generated voltage to at least one charging roller according to voltage applied to a transfer roller. Accordingly, the charging voltage supply can compensate for the charging voltage in view of the reduction of a charging potential of a photosensitive body according to the transfer voltage.

### CROSS-REFERENCE TO RELATED APPLICATIONS

This application claims the benefit under 35 U.S.C. §119(a) of Korean Patent Application No. 2006-6684 filed on Jan. 23, 2006, in the Korean Intellectual Property Office, the entire disclosure of which is hereby incorporated by reference.

### BACKGROUND OF THE INVENTION

1. Field of the Invention

The present invention relates to a charging voltage supply and a method for supplying charging voltage. More particularly, the present invention relates to a charging voltage supply that can compensate for the charging voltage in view of a reduction of charging potential of a photosensitive body depending on a transfer voltage, and a method for supplying charging voltage.

2. Description of the Related Art

In order to form an image at a high speed, a color image forming apparatus employing a conventional overlay transfer scheme has a plurality of color image forming units that are arranged in a driving direction of a transfer belt, and overlays each other on a toner image to form an overlaid image on the transfer belt. This is also called a tandem color image forming apparatus. Generally, the plurality of color image forming units is arranged in a driving direction of the transfer belt to develop an image with each color of yellow (Y), magenta (M), cyan (C), and black (K).

FIG. 1 is a graph illustrating a charging potential of a photosensitive body according to a transfer voltage.

Referring to FIG. 1, the charging potential of a photosensitive body is not significantly reduced until the transfer voltage T1 is 1.5 kV, but as the transfer voltage T1 reaches 1.65 kV and above, the charging potential is significantly reduced.

In a tandem overlay transfer scheme, when a toner is overlaid and transferred, a resistance of the toner layer increases. Therefore, the applied transfer voltage is gradually increased. However, as the transfer voltage is gradually increased, the charging potential of the photosensitive body is significantly reduced as shown in FIG. 1.

### SUMMARY OF THE INVENTION

An aspect of exemplary embodiments of the present invention is to address at least the above problems and/or advantages and to provide at least the advantages described below. Accordingly, an aspect of exemplary embodiments of the present invention is to provide a charging voltage supply that can compensate for charging voltage in view of a reduction of charging potential of a photosensitive body depending on a transfer voltage, and a method for supplying charging voltage.

To achieve the first object of exemplary embodiments of the present invention, there is provided a charging voltage supply including a power generator, and a branch to branch the voltage generated by the power generator, to at least one charging roller according to voltage applied to a transfer roller.

In an exemplary implementation, the branch may branch the voltage to the charging roller using at least one voltage reduction member.

In another exemplary implementation, the voltage reduction member may comprise a resistance element that varies depending on the voltage applied to the transfer roller.

To achieve the second object of exemplary embodiments of the present invention, there is provided a method for supplying charging voltage, including operations of generating voltage, and branching the generated voltage to at least one charging roller according to voltage applied to a transfer roller.

In an exemplary implementation, the operation of branching may branch the voltage to the charging roller using at least one voltage reduction member.

In another exemplary implementation, the voltage reduction member may comprise a resistance element that varies depending on the voltage applied to the transfer roller.

### BRIEF DESCRIPTION OF THE DRAWINGS

The above and other objects, features, and advantages of certain exemplary embodiments of the present invention will be more apparent from the following description taken in conjunction with the accompanying drawings, in which:

FIG. 1 is a graph illustrating charging potential of a photosensitive body according to a transfer voltage consistent with a conventional art;

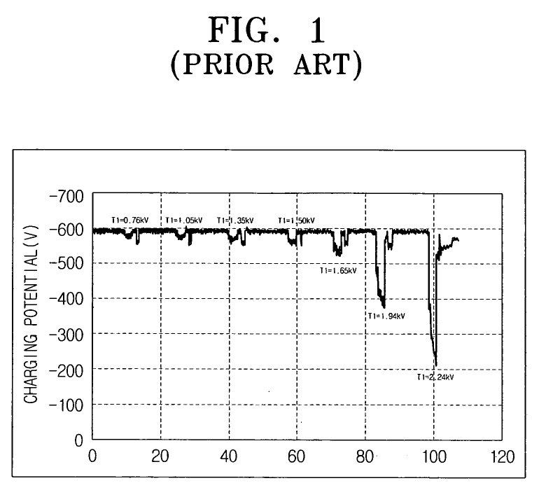

FIG. 2 is a schematic view illustrating a color image forming apparatus employing an apparatus for supplying charging voltage according to an exemplary embodiment of the present invention;

FIG. 3 is a schematic view illustrating a color image forming apparatus employing an apparatus for supplying charging voltage according to an exemplary embodiment of the present invention; and

FIG. 4 is a graph illustrating a charging potential reduction of a photosensitive body according to a transfer voltage to explain an exemplary embodiment of the present invention.

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for conciseness and clarity.

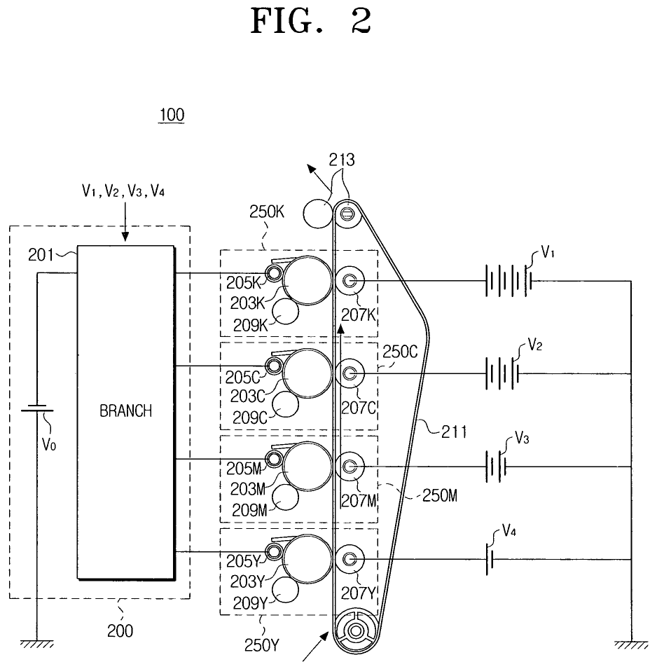

FIG. 2 is a schematic view illustrating a color image forming apparatus employing an apparatus for supplying charging voltage according to an exemplary embodiment of the present invention.

Referring to FIG. 2, the color image forming apparatus 100 comprises a plurality of color image forming units 250K, 250C, 250M, and 250Y, a fixing roller 213, a transfer belt 211, a charging voltage supply 200, and power generators V1, V2, V3, and V4.

The plurality of color image forming units 250K, 250C, 250M, and 250Y has a yellow (Y) image forming unit 250Y, magenta (M) image forming unit 250M, cyan (C) image forming unit 250C, and black (K) image forming unit 250K that are arranged in a driving direction, as illustrated by arrows in FIG. 2, of the transfer belt 211.

The plurality of color image forming units 250K, 250C, 250M, and 250Y comprise photosensitive bodies 203K, 203C, 203M and 203Y to transfer an image onto the transfer belt 211, transfer rollers 207K, 207C, 207M, 207Y opposed to the photosensitive bodies 203K, 203C, 203M and 203Y based on the transfer belt 211, developing rollers 209K, 209C, 209M, and 209Y to develop an electrostatic latent image formed on the photosensitive bodies 203K, 203C, 203M and 203Y with developer such as toner or ink, and charging rollers 205K, 205C, 205M and 205Y provided at one side of the photosensitive bodies 203K, 203C, 203M and 203Y to charge surfaces of the photosensitive bodies 203K, 203C, 203M and 203Y.

The transfer belt 211 transfers color images formed by the plurality of color image forming units 250K, 250C, 250M, and 250Y to the fixing roller 213.

The fixing roller 213 fixes the color image formed on the transfer belt 211 onto a printing paper supplied from a paper feeding device (not shown).

The power generators V1, V2, V3, and V4 independently generate voltage to supply to the plurality of transfer rollers 207K, 207C, 207M, 207Y. In an exemplary implementation, the power generators V1, V2, V3, and V4 separately supply voltage to each of the transfer rollers 207K, 207C, 207M, and 207Y. However, the separate supply of voltage should not be considered as limiting. One power generator may be employed to supply voltage to the plurality of transfer rollers 207K, 207C, 207M, and 207Y.

The charging voltage supply 200 according to an exemplary embodiment of the present invention comprises a power generator V0 and a branch 201.

The power generator V0 generates voltage (hereafter, referred to charging voltage) to supply to the charging rollers 205K, 205C, 205M, and 205Y.

The branch 201 branches and supplies the voltage generated by the power generator V0 to the charging rollers 205K, 205C, 205M, and 205Y. Preferably, the branch 201 branches the voltage in view of influence of the voltage V1, V2, V3, V4 (hereafter, referred to transfer voltage) applied to the transfer rollers 207K, 207C, 207M, and 207Y. For example, the branch 201 has proper voltage reduction elements to branch different charging voltages to each of the charging rollers 205K, 205C, 205M, and 205Y. The voltage reduction elements vary depending on values of the transfer voltage.

The branch 201 according to an exemplary embodiment of the present invention may receive transfer voltage information to branch the voltage generated by the power generator V0 to the charging rollers 205K, 205C, 205M, and 205Y according to the received transfer voltage information. The transfer voltage information refers to the transfer voltage itself or information equivalent to the transfer voltage information. The transfer voltage information shows an influence that the voltage generated on the photosensitive bodies 203K, 203C, 203M, and 203Y is exerted by the voltage applied to the transfer rollers 207K, 207C, 207M, and 207Y.

The branch 201 can branch the voltage generated by the power generator V0 to the transfer rollers 207K, 207C, 207M, and 207Y using a voltage reduction member such as a resistance element that has values varying in response to the voltage of the transfer rollers 207K, 207C, 207M, and 207Y. If the transfer voltage, that is applied by color to the transfer rollers 207K, 207C, 207M, and 207Y, is maintained as a constant value, the branch 201 may use a voltage reduction member with a constant value.

FIG. 2 shows the color image forming apparatus 100 employing one power generator V0 to supply charging voltage of the plurality of the charging rollers 205K, 205C, 205M, and 205Y. However, the image forming apparatus may take another configuration from FIG. 2.

For example, the color image forming apparatus 100 may employ a plurality of power generators V0 to individually supply voltage to the plurality of charging rollers 205K, 205C, 205M, and 205Y. In an exemplary implementation, each voltage generated by the plurality of power generators V0 may have different values. This is to consider the influence by the transfer voltage.

The plurality of power generators V0 receive feedback regarding the transfer voltage information by color, and generate each charging voltage based on the fed back transfer voltage information to supply the charging voltage to the charging rollers 205K, 205C, 205M, and 205Y.

If the color image forming apparatus 100 employs a plurality of power generators V0 to individually supply to the plurality of charging rollers 205K, 205C, 205M, and 205Y, the plurality of power generators V0 may generate the same voltages.

In this configuration, to consider the transfer voltage, the voltage generated by the plurality of power generators V0 is not directly supplied to the charging rollers 205K, 205C, 205M, and 205Y but can be supplied via each element having different voltage reduction values to the charging rollers 205K, 205C, 205M, and 205Y.

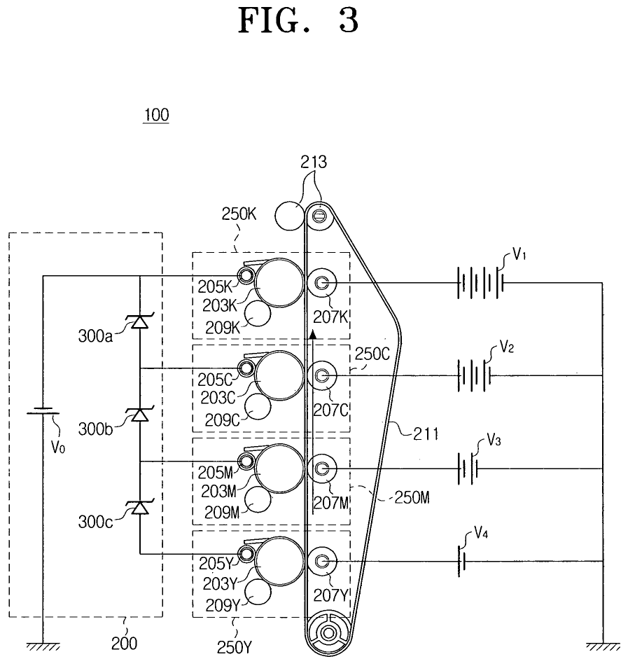

FIG. 3 is a schematic view of a color image forming apparatus employing a charging voltage supply according to an exemplary embodiment of the present invention.

Referring to FIG. 3, the image forming apparatus 100 employing the charging voltage supply comprises a color image forming unit 250, fixing roller 213, transfer belt 211, charging voltage supply 200, and power generators V1, V2, V3, and V4. The members having the same reference numbers as those of FIG. 2 may operate the same as FIG. 2.

A branch 201 of the charging voltage supply 200 according to an exemplary embodiment of the present invention comprises a Zener diode. The branch 201 is configured on the assumption that the transfer voltage by color is constant.

In an exemplary implementation, the branch 201 comprises a plurality of Zener diodes 300a, 300b, and 300c to constantly reduce the voltage of the charging rollers 205K, 205C, 205M, and 205Y.

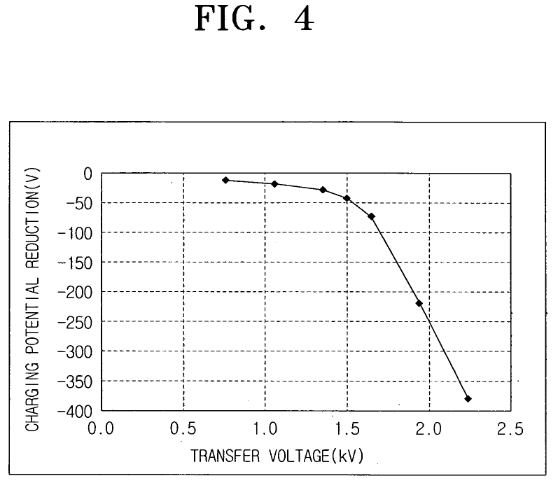

FIG. 4 is a graph illustrating a charging potential reduction of a photosensitive body according to a transfer voltage in order to explain the present invention.

Referring to FIGS. 4 and 2, FIG. 4 is a graph illustrating a reduction of charging potential of the photosensitive bodies 203K, 203C, 203M, and 203Y according to voltage applied to the transfer rollers 207K, 207C, 207M, and 207Y. As the voltage applied to the transfer rollers 207K, 207C, 207M, and 207Y becomes greater, the charging potential of the photosensitive bodies 203K, 203C, 203m, and 203Y becomes less.

Accordingly, the branch 201 compensates for the reduction of the charging potential according to the transfer voltage using the variable resistance element and then can branch the charging voltage. A person skilled in the art may set values of the Zener diodes of FIG. 3 with reference to the graph of FIG. 4.

As described above, according to exemplary embodiments of the present invention, the charging voltage supply can compensate for the charging voltage in view of the reduction of the charging potential of the photosensitive body according to the transfer voltage.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A charging voltage supply comprising:
a power generator generating a voltage for at least one transfer roller; and
a branch for branching the voltage generated by the power generator to at least one charging roller according to voltage applied to the at least one transfer roller.

2. The charging voltage supply as claimed in claim 1, wherein the branch branches the voltage to the at least one charging roller using at least one voltage reduction member.

3. The charging voltage supply as claimed in claim 2, wherein the voltage reduction member comprises a resistance element that varies according to the voltage applied to the at least one transfer roller.

4. A method for supplying a charging voltage, comprising:
generating voltage for at least one transfer roller; and
branching the generated voltage to at least one charging roller according to voltage applied to the at least one transfer roller.

5. The method as claimed in claim 4, wherein the operation of branching comprises branching the voltage to the at least one charging roller using at least one voltage reduction member.

6. The method as claimed in claim 5, wherein the voltage reduction member comprises a resistance element that varies according to the voltage applied to the at least one transfer roller.

7. The charging voltage supply as claimed in claim 2, wherein the voltage reduction element comprises at least one Zener diode.

8. The method as claimed in claim 6, wherein the voltage reduction element comprises at least one Zener diode.
